(19) United States
(12) Patent Application Publication
(10) Pub. No.: US 2024/0385093 A1
(43) Pub. Date: Nov. 21, 2024

(54) SIMILAR MATERIAL FOR ROCK SLOPE MODEL TEST UNDER WATER-ROCK INTERACTION, AND PREPARATION METHOD AND USE THEREOF

(71) Applicant: WUHAN UNIVERSITY, Wuhan City (CN)

(72) Inventors: Yong LIU, Wuhan City (CN); Po CHENG, Wuhan City (CN); Shunping REN, Wuhan City (CN); Libin SU, Wuhan City (CN); Manman LIU, Wuhan City (CN)

(73) Assignee: WUHAN UNIVERSITY, Wuhan City (CN)

(21) Appl. No.: 18/605,657

(22) Filed: Mar. 14, 2024

(30) Foreign Application Priority Data
May 15, 2023 (CN) 202310554706.1

(51) Int. Cl. G01N 3/62; C04B 14/06; C04B 14/34; C04B 14/36; C04B 16/04; C04B 24/06; C04B 28/14; C04B 40/00; C04B 111/00

(52) U.S. Cl. CPC G01N 3/62; C04B 14/06; C04B 14/34; C04B 14/368; C04B 16/04; C04B 24/06; C04B 28/14; C04B 40/0046; C04B 2111/00991; G01N 2203/0284

(57) ABSTRACT

Provided are a similar material for a rock slope model test under water-rock interaction, and a preparation method and use thereof. The similar material is prepared from raw materials including the following components: an iron powder, a quartz sand, a barite powder, a gypsum, glycerin, water, a gypsum retarding agent, and a dispersible polymer powder. Further, the method for preparing the similar material for a rock slope model test under water-rock interaction is also provided.

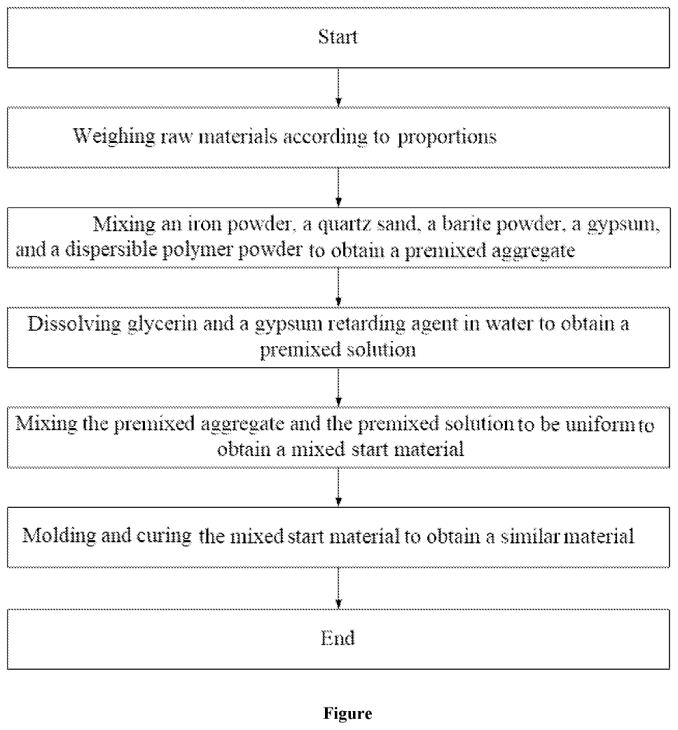

### CROSS REFERENCE TO RELATED APPLICATION

This application claims foreign priority benefits under 35 U.S.C. § 119 (a)-(d) to Chinese Patent Application No. 202310554706.1 filed on May 15, 2023, the disclosure of which is hereby incorporated herein by reference in its entirety.

### TECHNICAL FIELD

The present disclosure relates to the technical field of geotechnical engineering, and in particular to a similar material for a rock slope model test under water-rock interaction, and a preparation method and use thereof.

### BACKGROUND

Large-scale water conservancy and hydropower projects, railways, and highways involves a large number of rock slopes, and these rock slopes will pose a great threat to the lives and properties of surrounding people once destabilized. When exposed to an environment, rock slopes are greatly affected by disturbances of the climate. In particular, dry-wet and heat-wet cycles caused by rainfall, reservoir water level changes, and freeze-thaw cycles make rock masses have different water occurrence environments and undergo different water-rock interactions. The long-term water-rock interaction will change the physical, mechanical, and hydraulic properties of the rock mass of a rock slope to cause the deterioration of performance of the rock mass to varying degrees, thereby significantly affecting the stability of the rock slope. Therefore, the research on the influence of water-rock interaction on the stability of a rock slope is of great engineering significance.

A similar model test is a research method where a site is scaled down as whole based on physical, mechanical, and temporal conditions according to the principles of similarity and then a test is conducted on a scaled site. In the prior art, model tests are used for studies in fields such as mining, water conservancy, and underground projects to solve many complicated and tough engineering geological problems, and a large number of research results are achieved accordingly. Model tests could be used to simulate important physical and mechanical properties of a prototype and reflect all or a part of characteristics of the prototype, which has many advantages, such as intuitive and reliable simulation of actual working conditions, convenient access to test results, and low testing expenses. The development of a similar material with stable properties, high similarity degree, and high reliability is an indispensable constituent part of the successful implementation of a model test.

A similar material to simulate a rock mainly includes an aggregate, a cementing agent, and a conditioning agent. Currently, common cementing agents could be mainly divided into two categories. One type uses cement as the cementing agent, which has high strength and is not easy to be adjusted. In addition, when the cement is adopted, the strength of such material will continuously increase with curing time, and thus a strength of a test sample cannot be controlled. The other type uses a gypsum as the cementing agent, while gypsum is easy to soften when exposed to water, such that it is not easy to adjust hydraulic properties of a test sample. Therefore, in order to conduct a rock slope similar model test under water-rock interaction, it is urgent to develop a similar material with stable physical and hydraulic properties.

### SUMMARY

In view of the above-mentioned deficiencies in the prior art, in a first aspect, the present disclosure provides a similar material for a rock slope model test under water-rock interaction, which is stable in physical and hydraulic properties and convenient for test control. The similar material is prepared from raw materials including the following components: an iron powder, a quartz sand, a barite powder, a gypsum, glycerin, water, a gypsum retarding agent, and a dispersible polymer powder.

After being dispersed, the dispersible polymer powder forms a film to play a reinforcing role as a second cementing agent and protect a colloid from being absorbed by a similar material system. When exposed to water, the film formed by the dispersible polymer powder will not be damaged or undergo secondary dispersion. The film formed by the dispersible polymer powder is distributed in the entire similar material system as a reinforcing material, which increases the cohesion force of the similar material, thereby ensuring the stability of physical mechanical and hydraulic properties of the similar material.

In some embodiments, the similar material is prepared from the raw materials including the following components in parts by weight: a part of the iron powder, b part of the quartz sand, c part of the barite powder, d part of the gypsum, e part of the glycerin, f part of the water, g part of the gypsum retarding agent, and h part of the dispersible polymer powder; and the parts by weight of the raw materials meets the following relationship:

$$a = 0.4 \times ( a + c ) - 0.7 \times ( a + c ) ,$$

$$b = 0.1 to 0.4 ,$$

$$d = 0.005 to 0.015 ,$$

$$e = 0.01 to 0.05 ,$$

$$f = 0.05 to 0.1 ,$$

$$g = 0.05 d to 0.3 d ,$$

$$h = 0.001 to 0.015 , and$$

$$a + b + c + d + e + f + g + h = 1.$$

In some embodiments, the iron powder has a standard mesh size of 100 mesh to 200 mesh.

In some embodiments, the quartz sand has a standard mesh size of 50 mesh to 100 mesh.

In some embodiments, the barite powder has a standard mesh size of 200 mesh to 400 mesh.

In some embodiments, the gypsum is at least one selected from the group consisting of an α-type high-strength gypsum and a β-type building gypsum.

In some embodiments, the gypsum retarding agent is at least one selected from the group consisting of a retarding agent of an organic acid and a soluble salt thereof, an alkaline phosphate retarding agent, and a protein retarding agent.

In some embodiments, the dispersible polymer powder is at least one selected from the group consisting of WACKER VINNAPAS 8031H and WACKER VINNAPAS 8034H; and both WACKER VINNAPAS 8031H and WACKER VINNAPAS 8034H are a terpolymer powder based on vinyl chloride, ethylene and viny laurate.

In a second aspect, the present disclosure provides a method for preparing the similar material for a rock slope model test under water-rock interaction described above, where the method involves a simple process, has excellent controllability, and includes the following steps:
S1. weighing raw materials according to proportions; and mixing the iron powder, the quartz sand, the barite powder, the gypsum, and the dispersible polymer powder to be uniform to obtain a premixed aggregate;
S2. dissolving the glycerin and the gypsum retarding agent in the water to obtain a premixed solution;
S3. mixing the premixed aggregate and the premixed solution to be uniform to obtain a mixed start material; and
S4. molding and curing the mixed start material to obtain the similar material for a rock slope model test under water-rock interaction.

In some embodiments, in S4, the curing is conducted at room temperature for 7 d to 14 d.

In a third aspect, the present disclosure provides use of the similar material for a rock slope model test under water-rock interaction described above in preparation of a rock slope prototype model (that is, a model with a similar material to an original rock of a rock slope).

In some embodiments, the use includes: according to properties and a size of a rock to be simulated, preparing the similar material for a rock slope model test under water-rock interaction into a rock slope prototype model.

Compared with the prior art, some embodiments of the present disclosure have the following advantages and beneficial effects.
1. The present disclosure provides a similar material for a rock slope model test under water-rock interaction. The raw material for preparing the similar material do not include substances harmful to the human health and are common and easy to acquire, resulting in a low cost. The addition of the dispersible polymer powder solves the technical problem that the cementing agent material is easy to be soften when exposed to water, thereby improving the stability of physical and hydraulic properties of the similar material.
2. The present disclosure also provides a method for preparing the similar material for a rock slope model test under water-rock interaction. The method involves simple operations and has excellent controllability.
3. The present disclosure provides use of the similar material for a rock slope model test under water-rock interaction in preparation of a rock slope prototype model. The waste produced after a test with the similar model will not cause pollution to an environment. In applications, the physical and mechanical, and hydraulic properties of the similar model could be flexibly changed by changing the ratio of components and the size of the similar model, which has a promising development prospect in the rock slope model test under water-rock interaction.

### BRIEF DESCRIPTION OF THE DRAWINGS

FIGURE is a flow chart of the method for preparing the similar material for a rock slope model test under water-rock interaction according to one embodiment of the present disclosure.

### DETAILED DESCRIPTION

The present disclosure is further described below with reference to examples, but is not thus limited to the scope of the examples. The experimental methods not specified in the specific conditions in the following examples are conducted according to conventional conditions or according to product instructions.

### Example 1

As shown in FIGURE, a similar material for a rock slope model test under water-rock interaction was prepared as follows.
S1. 0.22 kg of a 200-mesh iron powder, 0.36 kg of a 60-mesh quartz sand, 0.32 kg of a 325-mesh barite powder, 0.005 kg of a β-type building gypsum, and 0.007 kg of WACKER VINNAPAS 8031H were weighted and then mixed to be uniform to obtain a premixed aggregate.
S2. 0.027 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 2

As shown in FIGURE, a similar material for a rock slope model test under water-rock interaction was prepared as follows.
S1. 0.27 kg of a 200-mesh iron powder, 0.35 kg of a 60-mesh quartz sand, 0.27 kg of a 325-mesh barite powder, 0.01 kg of a β-type building gypsum, and 0.011 kg of WACKER VINNAPAS 8031H were weighted and then mixed to be uniform to obtain a premixed aggregate.
S2. 0.028 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 3

As shown in FIGURE, a similar material for a rock slope model test under water-rock interaction was prepared as follows.
S1. 0.32 kg of a 200-mesh iron powder, 0.36 kg of a 60-mesh quartz sand, 0.21 kg of a 325-mesh barite powder, 0.015 kg of a β-type building gypsum, and 0.004 kg of WACKER VINNAPAS 8031H were weighted and then mixed to be uniform to obtain a premixed aggregate.
S2. 0.03 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 4

As shown in FIGURE, a similar material for a rock slope model test under water-rock interaction was prepared as follows.
S1. 0.25 kg of a 200-mesh iron powder, 0.27 kg of a 60-mesh quartz sand, 0.37 kg of a 325-mesh barite powder, 0.01 kg of a β-type building gypsum, and 0.004 kg of WACKER VINNAPAS 8031H were weighted and then mixed to be uniform to obtain a premixed aggregate.
S2. 0.035 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 5

As shown in FIGURE, a similar material for a rock slope model test under water-rock interaction was prepared as follows.
S1. 0.31 kg of a 200-mesh iron powder, 0.26 kg of a 60-mesh quartz sand, 0.31 kg of a 325-mesh barite powder, 0.015 kg of a β-type building gypsum, and 0.008 kg of WACKER VINNAPAS 8031H were weighted and then mixed to be uniform to obtain a premixed aggregate.
S2. 0.036 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 6

As shown in FIGURE, a similar material for a rock slope model test under water-rock interaction was prepared as follows.
S1. 0.28 kg of a 200-mesh iron powder, 0.18 kg of a 60-mesh quartz sand, 0.42 kg of a 325-mesh barite powder, 0.015 kg of a β-type building gypsum, and 0.006 kg of WACKER VINNAPAS 8031H were weighted and then mixed to be uniform to obtain a premixed aggregate.
S2. 0.038 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 7

As shown in FIGURE, a similar material for a rock slope model test under water-rock interaction was prepared as follows.
S1. 0.42 kg of a 200-mesh iron powder, 0.18 kg of a 60-mesh quartz sand, 0.28 kg of a 325-mesh barite powder, 0.01 kg of a β-type building gypsum, and 0.011 kg of WACKER VINNAPAS 8031H were weighted and then mixed to be uniform to obtain a premixed aggregate.
S2. 0.038 kg of glycerin and 0.001 kg of a protein retarding agent were dissolved in 0.06 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Example 8

as shown in FIGURE, a similar material for a rock slope model test under water-rock interaction was prepared as follows.
S1. 0.333 kg of a 100-mesh iron powder, 0.1 kg of a 50-mesh quartz sand, 0.4995 kg of a 200-mesh barite powder, 0.005 kg of a a-type high-strength gypsum, and 0.001 kg of WACKER VINNAPAS 8034H were weighted and then mixed to be uniform to obtain a premixed aggregate.
S2. 0.01 kg of glycerin and 0.0015 kg of a retarding agent of an organic acid and a soluble salt thereof were dissolved in 0.05 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 14 d to obtain the similar material for a rock slope model test under water-rock interaction.

### Example 9

As shown in FIGURE, a similar material for a rock slope model test under water-rock interaction was prepared as follows.
S1. 0.293 kg of a 200-mesh iron powder, 0.4 kg of a 100-mesh quartz sand, 0.126 kg of a 400-mesh barite powder, 0.015 kg of a β-type building gypsum, and 0.015 kg of WACKER VINNAPAS 8031H were weighted and then mixed to be uniform to obtain a premixed aggregate.
S2. 0.05 kg of glycerin and 0.001 kg of an alkaline phosphate retarding agent were dissolved in 0.1 kg of purified water to obtain a premixed solution.
S3. The premixed aggregate and the premixed solution were mixed to be uniform to obtain a mixed start material.
S4. The mixed start material was placed in a mold, compacted for molding and then demolded. A resulting product was cured at room temperature for 7 d to obtain the similar material for a rock slope model test under water-rock interaction.

### Test Example 1

The physical and mechanical, and hydraulic property parameters of the similar materials in some examples of the present disclosure were tested. The volume of the similar material samples was measured and recorded, and the density of the similar material samples was calculated by the weighing method. A similar material sample was soaked in water and then taken out, the dry weight of the same before soaking and the wet weight of the same after soaking were determined by the weighing method, and then the water absorption rate was calculated. The uniaxial compressive strength and the softening coefficient of the similar material sample were measured by a uniaxial compression apparatus. The cohesion force and internal friction angle of the similar material sample were measured by a triaxial compression apparatus, and the permeability coefficient of the similar material sample was measured by a permeability testing apparatus. Test results of the physical and mechanical, and hydraulic property parameters of the similar materials are shown in Table 1.

TABLE 1
Test results of physical and mechanical, and hydraulic
property parameters of the similar materials

| | Physical and mechanical property parameters | | | | | | |
|---|---|---|---|---|---|---|---|
| | | Uniaxial | | Internal | Hydraulic property parameters | | |
| | | compressive | Cohesion | friction | Permeability | Water | |
| | Density | strength | force | angle | coefficient | absorption | Softening |
| Name | (g · cm⁻³) | (MPa) | (kPa) | (°) | (m · s⁻¹) | rate (%) | coefficient |
| Example 1 | 2.50 | 2.4 | 1030.1 | 37.6 | 4.4 × 10⁻⁸ | 2.31 | 0.89 |
| Example 2 | 2.61 | 2.8 | 807.9 | 48.4 | 3.3 × 10⁻⁸ | 3.25 | 0.88 |
| Example 3 | 2.67 | 2.31 | 910.7 | 40.5 | 2.7 × 10⁻⁸ | 2.14 | 0.81 |
| Example 4 | 2.56 | 0.72 | 305.3 | 30.1 | 8.9 × 10⁻⁸ | 5.19 | 0.82 |
| Example 5 | 2.65 | 1.62 | 776.9 | 37.2 | 8.6 × 10⁻⁸ | 2.37 | 0.90 |
| Example 6 | 2.62 | 1.93 | 607.3 | 44.4 | 6.5 × 10⁻⁸ | 2.67 | 0.86 |
| Example 7 | 2.88 | 1.63 | 475.8 | 46.1 | 7.9 × 10⁻⁸ | 3.45 | 0.83 |

It can be seen from the test results that the physical and mechanical, and hydraulic property parameters of the similar materials with different component proportions are stable and could vary in a wide range, which could meet the requirements of similar materials in most of rock slope model tests under water-rock interaction. The similar materials in the examples in the table have a relatively-high softening coefficient and excellent water resistance, and are not easy to be soften when exposed to water. The water resistance refers to the ability of a material to resist water damage. The damage of water to properties of model materials is reflected in different aspects, and the most obvious aspect is the reduction of mechanical properties of the model material. The water resistance is generally reflected by a softening coefficient, and it is generally believed that a material with a softening coefficient of greater than 0.85 is a water-resistant material. When a gypsum is adopted as a cementing agent in the prior art, a softening coefficient of a resulting similar material is between 0.2 and 0.4. The similar material according to the present disclosure has a softening coefficient of about 0.85 or close to 0.85, and has stable hydraulic properties. When a rock with unstable hydraulic properties is to be simulated, a desired softening coefficient could be allowed by adjusting a content of the dispersible polymer powder. In the present disclosure, a proportion of the components of the similar material could be adjusted to significantly change physical, mechanical, and hydraulic property parameters of the similar material, which makes it possible to simulate rocks with different properties to carry out a rock slope model test under water-rock interaction.

Some specific embodiments of the present disclosure are described in detail above. It should be understood that various modifications and variations could be made by a person of ordinary skill in the art without creative efforts according to the concept of the present disclosure. Therefore, all technical solutions that could be obtained by a person skilled in the art based on the prior art through logical analysis, reasoning, or finite experiments according to the concept of the present disclosure shall fall within the scope defined by the appended claims.

What is claimed is:

1. A similar material for a rock slope model test under water-rock interaction, wherein the similar material is prepared from raw materials comprising the following components: an iron powder, a quartz sand, a barite powder, a gypsum, glycerin, water, a gypsum retarding agent, and a dispersible polymer powder.

2. The similar material for the rock slope model test under the water-rock interaction according to claim 1, wherein the similar material is prepared from the raw materials comprising the following components in parts by weight: a part of the iron powder, b part of the quartz sand, c part of the barite powder, d part of the gypsum, e part of the glycerin, f part of the water, g part of the gypsum retarding agent, and h part of the dispersible polymer powder; and
the parts by weight of the raw materials meets the following relationship:
$$a = 0.4 \times ( a + c ) to 0.7 \times ( a + c ) ,$$
$$b = 0.1 to 0.4 ,$$
$$d = 0.005 to 0.015 ,$$
$$e = 0.01 to 0.05 ,$$
$$f = 0.05 to 0.1 ,$$
$$g = 0.05 d to 0.3 d ,$$
$$h = 0.001 to 0.015 , and$$
$$a + b + c + d + e + f + g + h = 1.$$

3. The similar material for the rock slope model test under the water-rock interaction according to claim 1, wherein the iron powder has a standard mesh size of 100 mesh to 200 mesh, the quartz sand has a standard mesh size of 50 mesh to 100 mesh, and the barite powder has a standard mesh size of 200 mesh to 400 mesh.

4. The similar material for the rock slope model test under the water-rock interaction according to claim 1, wherein the gypsum is at least one selected from the group consisting of an α-type high-strength gypsum and a β-type building gypsum.

5. The similar material for the rock slope model test under the water-rock interaction according to claim 1, wherein the gypsum retarding agent is at least one selected from the group consisting of a retarding agent of an organic acid and a soluble salt thereof, an alkaline phosphate retarding agent, and a protein retarding agent.

6. A method for preparing the similar material for the rock slope model test under the water-rock interaction according to claim 1, comprising the following steps:
S1. weighing the raw materials according to proportions; and mixing the iron powder, the quartz sand, the barite powder, the gypsum, and the dispersible polymer powder to be uniform to obtain a premixed aggregate;
S2. dissolving the glycerin and the gypsum retarding agent in the water to obtain a premixed solution;
S3. mixing the premixed aggregate and the premixed solution to be uniform to obtain a mixed start material; and
S4. molding and curing the mixed start material to obtain the similar material for a rock slope model test under water-rock interaction.

7. The method according to claim 6, wherein in S4, the curing is conducted at room temperature for 7 d to 14 d.

8. A method for preparing a rock slope prototype model, comprising using the similar material for the rock slope model test under the water-rock interaction according to claim 1.

9. The method for preparing the rock slope prototype model according to claim 8, further comprising,
according to properties and a size of a rock to be simulated, preparing the similar material for the rock slope model test under the water-rock interaction into the rock slope prototype model.

10. The method for preparing the similar material for the rock slope model test under the water-rock interaction according to claim 6, wherein the similar material is prepared from the raw materials comprising the following components in parts by weight: a part of the iron powder, b part of the quartz sand, c part of the barite powder, d part of the gypsum, e part of the glycerin, f part of the water, g part of the gypsum retarding agent, and h part of the dispersible polymer powder; and
the parts by weight of the raw materials meets the following relationship:
$$a = 0.4 \times ( a + c ) to 0.7 \times ( a + c ) ,$$
$$b = 0.1 to 0.4 ,$$
$$d = 0.005 to 0.015 ,$$
$$e = 0.01 to 0.05 ,$$
$$f = 0.05 to 0.1 ,$$
$$g = 0.05 d to 0.3 d ,$$
$$h = 0.001 to 0.015 , and$$
$$a + b + c + d + e + f + g + h = 1.$$

11. The method for preparing the similar material for the rock slope model test under the water-rock interaction according to claim 6, wherein the iron powder has a standard mesh size of 100 mesh to 200 mesh, the quartz sand has a standard mesh size of 50 mesh to 100 mesh, and the barite powder has a standard mesh size of 200 mesh to 400 mesh.

12. The method for preparing the similar material for the rock slope model test under the water-rock interaction according to claim 6, wherein the gypsum is at least one selected from the group consisting of an α-type high-strength gypsum and a β-type building gypsum.

13. The method for preparing the similar material for the rock slope model test under the water-rock interaction according to claim 6, wherein the gypsum retarding agent is at least one selected from the group consisting of a retarding agent of an organic acid and a soluble salt thereof, an alkaline phosphate retarding agent, and a protein retarding agent.
